(19) United States
(12) Patent Application Publication
(10) Pub. No.: US 2026/0195683 A1
(43) Pub. Date: Jul. 9, 2026

(54) DETECTION AND MANAGEMENT OF ANOMALIES IN ASSESSMENT DATA

(71) Applicant: International Business Machines Corporation, Armonk, NY (US)

(72) Inventors: Behnam Manavi Tehrani, Fort Collins, CO (US); Randall Funke, Norwalk, CT (US); Sandeep reddy Reddy, Cary, NC (US)

(21) Appl. No.: 19/008,667

(22) Filed: Jan. 3, 2025

(51) Int. Cl. G06Q 10/0635; G06N 20/00

(52) U.S. Cl. CPC G06Q 10/0635; G06N 20/00

(57) ABSTRACT

Detection and management of anomalies in assessment data include receiving structured assessment data, including questions and responses, and detecting anomalies based on defined risk parameters and logic rules to evaluate data integrity, accuracy, and compliance. The system identifies specific reasons for each detected anomaly, generating actionable recommendations to address these issues. Finally, the system outputs both the anomaly data and corresponding recommendations, facilitating informed decision-making and risk management for the first entity. This approach enhances the efficiency and reliability of the evaluation process, ultimately improving organizational security practices.

### BACKGROUND

The disclosure relates to supply chain and risk management and more particularly, to detection and management of anomalies in assessment data.

In the contemporary landscape of large enterprises, the governance and implementation of security measures are critical for mitigating risks associated with both intentional and unintentional threats. Organizations establish specialized teams focused on specific objectives within a supply chain and risk management framework. The specialized teams predominantly rely on Third-Party Risk Management (TPRM) platforms to evaluate the security posture and compliance of their suppliers. The TPRM platforms play a pivotal role in ensuring that suppliers meet organizational standards and regulatory requirements, ultimately safeguarding the enterprise from potential vulnerabilities.

### SUMMARY

According to an embodiment of the disclosure, a computer-implemented method for the detection and management of anomalies in assessment data is described. The computer-implemented method includes receiving assessment data associated with a first entity. The assessment data includes at least a set of questions and a first set of responses for the set of questions. The set of questions is associated with an evaluation of the first entity conducted by a second entity about an operational activity. The computer-implemented method further includes detecting a first set of anomalies in the assessment data based on one or more risk parameters associated with the first entity and a set of logic rules. The set of logic rules is rules associated with the assessment data to evaluate an integrity of the assessment data, an accuracy of the assessment data, and compliance of the assessment data. Further, the computer-implemented method includes generating anomaly data associated with the first set of anomalies based on the assessment data and the first set of anomalies. The anomaly data is indicative of a set of reasons for an occurrence of each anomaly of the first set of anomalies in the assessment data. The computer-implemented method further includes generating a set of recommendations based on the anomaly data, the first set of anomalies, and the assessment data. The set of recommendations is generated to resolve the first set of anomalies. The computer-implemented method further includes outputting the anomaly data and the set of recommendations.

According to one or more embodiments of the disclosure, a computer system for the detection and management of anomalies in assessment data is described. The computer system includes a processor set, one or more computer-readable storage media, and program instructions stored on the one or more computer-readable storage media. The program instructions executable by the processor set to cause the processor set to receive assessment data associated with a first entity. The assessment data includes at least a set of questions and a first set of responses for the set of questions. The set of questions is associated with an evaluation of the first entity conducted by a second entity about an operational activity. The program instructions executable by the processor set to cause the processor set to detect a first set of anomalies in the assessment data based on one or more risk parameters associated with the first entity and a set of logic rules. The set of logic rules is rules associated with the assessment data to evaluate an integrity of the assessment data, an accuracy of the assessment data, and compliance of the assessment data. Further, the program instructions executable by the processor set to cause the processor set to generate anomaly data associated with the first set of anomalies based on the assessment data and the first set of anomalies. The anomaly data is indicative of a set of reasons for an occurrence of each anomaly of the first set of anomalies in the assessment data. The program instructions executable by the processor set to cause the processor set to generate a set of recommendations based on the anomaly data, the first set of anomalies, and the assessment data. The set of recommendations is generated to resolve the first set of anomalies. The program instructions executable by the processor set to cause the processor set to output the anomaly data and the set of recommendations.

According to one or more embodiments of the disclosure, a computer program product for the detection and management of anomalies in assessment data is described. The computer program product includes one or more computer-readable storage medium and program instructions stored on the one or more computer-readable storage media to perform operations. The operations include receiving assessment data associated with a first entity. The assessment data includes at least a set of questions and a first set of responses for the set of questions. The set of questions is associated with an evaluation of the first entity conducted by a second entity about an operational activity. The operations further include detecting a first set of anomalies in the assessment data based on one or more risk parameters associated with the first entity and a set of logic rules. The set of logic rules is rules associated with the assessment data to evaluate an integrity of the assessment data, an accuracy of the assessment data, and compliance of the assessment data. Further, the operations include generating anomaly data associated with the first set of anomalies based on the assessment data and the first set of anomalies. The anomaly data is indicative of a set of reasons for an occurrence of each anomaly of the first set of anomalies in the assessment data. The operations further include generating a set of recommendations based on the anomaly data, the first set of anomalies, and the assessment data. The set of recommendations is generated to resolve the first set of anomalies. The operations further include outputting the anomaly data and the set of recommendations.

Additional technical features and benefits are realized through the techniques of the disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures wherein:

FIG. 1 is a diagram that illustrates a computing environment for the detection and management of anomalies in assessment data, in accordance with an embodiment of the disclosure;

FIG. 2 is a diagram that illustrates a network environment for the detection and management of the anomalies, in accordance with an embodiment of the disclosure;

FIG. 3 is a diagram that illustrates an environment for depicting a process of detecting and managing the anomalies, in accordance with an embodiment of the disclosure;

FIG. 4 is a diagram that illustrates a system-level architecture of a system for the detection and management of the anomalies, in accordance with an embodiment of the disclosure;

FIG. 5 is a diagram that illustrates exemplary operations for the detection and management of the anomalies, in accordance with an embodiment of the disclosure;

FIG. 6 is a diagram that illustrates a system-level architecture of a first AI model, in accordance with an embodiment of the disclosure;

FIG. 7 is a diagram that illustrates a system-level architecture of a second AI model, in accordance with an embodiment of the disclosure;

FIG. 8 is a diagram that illustrates exemplary operations for training the first AI model and the second AI model, in accordance with an embodiment of the disclosure;

FIG. 9 illustrates a diagram depicting an architecture for evaluating assessment data, in accordance with an embodiment of the disclosure; and

FIG. 10 is a diagram that illustrates a flowchart of an exemplary computer-implemented method for the detection and management of the anomalies, in accordance with an embodiment of the disclosure.

### DETAILED DESCRIPTION

With the advancements in technology, the effective governance and implementation of security measures are used for mitigating various risks posed by both intentional and unintentional threats. Organizations use specialized teams, each team tasked with distinct missions focused on enhancing a security framework, particularly within supply chain management. The specialized teams increasingly rely on Third-Party Risk Management (TPRM) platforms to rigorously evaluate the security posture and compliance of their suppliers. However, a significant challenge arises from the initial data submissions made by users, which frequently contain inaccuracies or incomplete information. This situation necessitates a cumbersome process of review and correction, characterized by multiple rounds of inquiries and exchanges between an organization's TPSRM team and prospective vendors, leading to inefficiencies and delays in the vendor evaluation timeline.

Further, a contract evaluation process for vendors is inherently complex, requiring meticulous manual examination of diverse information sets submitted by suppliers, including SOC audit reports, penetration test results, and Supplier Request Questionnaires (SRQs). This current workflow faces severe constraints, as the volume of incoming requests significantly outstrips the capacity of the assessor to conduct thorough evaluations within the timeframes dictated by organizational policies. As assessors are often evaluated based on the length of time, suppliers remain in a pending status, there is an urgent need to improve productivity and expedite decision-making processes. To tackle these inefficiencies, intelligent systems capable of preprocessing the submissions are required. The intelligent systems may enhance the efficiency and reliability of the overall risk management process through advanced computational methodologies and natural language processing processes.

Despite notable technological advancements, existing TPRM platforms predominantly rely on static templates and manual review processes for unstructured data. While the TRPM platforms offer some degree of automation in data collection and risk assessment, the TRPM platforms fall short of providing the sophisticated text analysis capabilities to dynamically evaluate free-text responses. This inadequacy presents a significant barrier to organizations aiming to manage the unstructured data prevalent in risk assessments effectively.

The proposed system seeks to address this critical gap by integrating real-time user feedback mechanisms, employing a Language Model (LM) for preprocessing free-text submissions, and enabling continuous learning through anonymized data. By significantly enhancing the accuracy and completeness of initial data entries, the proposed system aims to alleviate the manual review burden, streamline the assessment workflow, and ensure ongoing improvements to the system. This approach aspires to strengthen organizational control and security within the broader framework of supply chain risk management, ultimately facilitating a more responsive and effective risk mitigation strategy.

According to an embodiment of the disclosure, a computer-implemented method for the detection and management of anomalies in assessment data is described. The computer-implemented method includes receiving, by a computer, assessment data associated with a first entity. The assessment data includes at least a set of questions and a first set of responses for the set of questions. The set of questions is associated with an evaluation of the first entity conducted by a second entity about an operational activity. The computer-implemented method further includes detecting, by the computer, a first set of anomalies in the assessment data based on one or more risk parameters associated with the first entity and a set of logic rules. The set of logic rules is rules associated with the assessment data to evaluate an integrity of the assessment data, an accuracy of the assessment data, and compliance of the assessment data. Further, the computer-implemented method includes generating, by the computer, anomaly data associated with the first set of anomalies based on the assessment data and the first set of anomalies. The anomaly data is indicative of a set of reasons for an occurrence of each anomaly of the first set of anomalies in the assessment data. The computer-implemented method further includes generating, by the computer, a set of recommendations based on the anomaly data, the first set of anomalies, and the assessment data. The set of recommendations is generated to resolve the first set of anomalies. The computer-implemented method further includes outputting, by the computer, the anomaly data and the set of recommendations.

In some embodiments of the disclosure, the computer-implemented method further includes applying, by the computer, a first set of logic rules of the set of logic rules to the assessment data. The computer-implemented method further includes detecting, by the computer, the first set of anomalies in the assessment data based on the one or more risk parameters and the application of the first set of logic rules to the assessment data. The computer-implemented method further includes outputting, by the computer, the first set of anomalies.

In some embodiments of the disclosure, the computer-implemented method includes applying, by the computer, a first Artificial Intelligence (AI) model on the assessment data and the first set of anomalies. The computer-implemented method further includes generating, by the computer, first anomaly data of the anomaly data based on the application of the first AI model on the assessment data and the first set of anomalies. The first anomaly data is indicative of at least a first reason of the set of reasons for the occurrence of each anomaly within the first set of anomalies. The computer-implemented method further includes outputting, by the computer, the first anomaly data.

In some embodiments of the disclosure, the first reason is associated with at least one of an absence of at least one response in a first set of responses, an occurrence of incorrect data formatting in the first set of responses, or an occurrence of a set of errors associated with a first set of criteria for the first set of responses.

In some embodiments of the disclosure, the computer-implemented method includes applying, by the computer, a second AI model on the first anomaly data, the first set of anomalies, and the assessment data. Further, the computer-implemented method includes generating, by the computer, a first set of recommendations of the set of recommendations based on the application of the second AI model on the first anomaly data, the first set of anomalies, and the assessment data. The first set of recommendations is generated to resolve the first set of anomalies. The computer-implemented method further includes outputting, by the computer, the first set of recommendations on a first electronic device associated with the first entity.

In some embodiments of the disclosure, the computer-implemented method includes receiving, by the computer, one or more inputs from the first electronic device associated with the first entity to update the assessment data. The one or more inputs are received based on the outputting of the first set of recommendations on the first electronic device. Further, the computer-implemented method includes updating, by the computer, the assessment data based on the one or more inputs. The updated assessment data includes at least one updated response associated with the first set of responses. Further, the computer-implemented method includes applying, by the computer, a second set of logic rules of the set of logic rules to the updated assessment data. Furthermore, the computer-implemented method includes detecting, by the computer, a second set of anomalies in the updated assessment data based on the application of the second set of logic rules to the updated assessment data. Furthermore, the computer-implemented method includes outputting, by the computer, the second set of anomalies.

In some embodiments of the disclosure, the computer-implemented method includes applying, by the computer, the first AI model on the updated assessment data and the second set of anomalies. Further, the computer-implemented method includes generating, by the computer, second anomaly data of the anomaly data based on the application of the first AI model on the updated assessment data and the second set of anomalies. The second anomaly data is indicative of at least a second reason of the set of reasons for the occurrence of each anomaly within the second set of anomalies. Further, the computer-implemented method includes applying, by the computer, the second AI model on the second anomaly data, the second set of anomalies, and the updated assessment data. Furthermore, the computer-implemented method includes generating, by the computer, a second set of recommendations of the set of recommendations based on the application of the second AI model on the second anomaly data, the second set of anomalies, and the updated assessment data. The second set of recommendations is generated to resolve the second set of anomalies. The computer-implemented method includes outputting, by the computer, the second anomaly data, and the second set of recommendations.

In some embodiments of the disclosure, the second reason includes at least one of an occurrence of one or more logical flaws in the at least one updated response, or an absence of at least one section of data in the at least one updated response.

In some embodiments of the disclosure, the computer-implemented method includes transmitting, by the computer, the assessment data to a second electronic device associated with the second entity. The second entity is responsible for the evaluation of the first entity about the operational activity. Further, the computer-implemented method includes obtaining, by the computer, response data from the second entity based on the transmission of the assessment data to the second electronic device. The response data is indicative of an occurrence of one or more anomalies in the assessment data. Further, the computer-implemented method includes determining, by the computer, a performance score associated with the first AI model based on the response data and the first set of anomalies. The performance score is associated with a performance of the first AI model for the detection of the first set of anomalies in the assessment data. Furthermore, the computer-implemented method includes validating, by the computer, the performance of the first AI model based on the performance score and a threshold performance score. The computer-implemented method includes training, by the computer, the first AI model based on the response data, and the first set of anomalies upon the validation of the performance of the first AI model.

In some embodiments of the disclosure, the computer-implemented method includes obtaining, by the computer, one or more recommendations from the second electronic device to resolve the first set of anomalies upon the transmission of the assessment data to the second electronic device. Further, the computer-implemented method includes validating, by the computer, a performance of the second AI model based on the one or more recommendations and the first set of recommendations. Further, the computer-implemented method includes training, by the computer, the second AI model based on the one or more recommendations, and the first set of recommendations upon the validation of the performance of the second AI model.

In some embodiments of the disclosure, the one or more risk parameters include financial stability indicators of the first entity, a regulatory compliance status of the first entity, security posture metrics of the first entity, and an incident history of the first entity.

According to one or more embodiments of the disclosure, a computer system for the detection and management of anomalies in assessment data is described. The computer system includes a processor set, one or more computer-readable storage media, and program instructions stored on the one or more computer-readable storage media. The program instructions executable by the processor set to cause the processor set to receive assessment data associated with a first entity. The assessment data includes at least a set of questions and a first set of responses for the set of questions. The set of questions is associated with an evaluation of the first entity conducted by a second entity about an operational activity. The program instructions executable by the processor set to cause the processor set to detect a first set of anomalies in the assessment data based on one or more risk parameters associated with the first entity and a set of logic rules. The set of logic rules is rules associated with the assessment data to evaluate an integrity of the assessment data, an accuracy of the assessment data, and compliance of the assessment data. Further, the program instructions executable by the processor set to cause the processor set to generate anomaly data associated with the first set of anomalies based on the assessment data and the first set of anomalies. The anomaly data is indicative of a set of reasons for an occurrence of each anomaly of the first set of anomalies in the assessment data. The program instructions executable by the processor set to cause the processor set to generate a set of recommendations based on the anomaly data, the first set of anomalies, and the assessment data. The set of recommendations is generated to resolve the first set of anomalies. The program instructions executable by the processor set to cause the processor set to output the anomaly data and the set of recommendations.

In some embodiments of the disclosure, the program instructions executable by the processor set to cause the processor set to apply a first set of logic rules of the set of logic rules to the assessment data. Further, the program instructions executable by the processor set to cause the processor set to detect the first set of anomalies in the assessment data based on the one or more risk parameters and the application of the first set of logic rules to the assessment data. Furthermore, the program instructions executable by the processor set to cause the processor set to output the first set of anomalies.

In some embodiments of the disclosure, the program instructions executable by the processor set to cause the processor set to apply a first Artificial Intelligence (AI) model on the assessment data and the first set of anomalies. The program instructions executable by the processor set to cause the processor set to generate first anomaly data of the anomaly data based on the application of the first AI model on the assessment data and the first set of anomalies. The first anomaly data is indicative of at least a first reason of the set of reasons for the occurrence of each anomaly within the first set of anomalies. Further, the program instructions executable by the processor set to cause the processor set to output the first anomaly data.

In some embodiments of the disclosure, the first reason is associated with at least one of an absence of at least one response in a first set of responses, an occurrence of incorrect data formatting in the first set of responses, or an occurrence of a set of errors associated with a first set of criteria for the first set of responses.

In some embodiments of the disclosure, the program instructions executable by the processor set to cause the processor set to apply a second AI model on the first anomaly data, the first set of anomalies, and the assessment data. Further, the program instructions executable by the processor set to cause the processor set to generate a first set of recommendations of the set of recommendations based on the application of the second AI model on the first anomaly data, the first set of anomalies, and the assessment data. The first set of recommendations is generated to resolve the first set of anomalies. Furthermore, the program instructions executable by the processor set to cause the processor set to output the first set of recommendations on a first electronic device associated with the first entity.

In some embodiments of the disclosure, the program instructions executable by the processor set to cause the processor set to receive one or more inputs from the first electronic device associated with the first entity to update the assessment data. The one or more inputs are received based on the outputting of the first set of recommendations on the first electronic device. Further, the program instructions executable by the processor set to cause the processor set to update the assessment data based on the one or more inputs. The updated assessment data includes at least one updated response associated with the first set of responses. Further, the program instructions executable by the processor set to cause the processor set to apply a second set of logic rules of the set of logic rules to the updated assessment data. Furthermore, the program instructions executable by the processor set to cause the processor set to detect a second set of anomalies in the updated assessment data based on the application of the second set of logic rules to the updated assessment data. Furthermore, the program instructions executable by the processor set to cause the processor set to output the second set of anomalies.

In some embodiments of the disclosure, the program instructions executable by the processor set to cause the processor set to apply the first AI model on the updated assessment data and the second set of anomalies. Further, the program instructions executable by the processor set to cause the processor set to generate second anomaly data of the anomaly data based on the application of the first AI model on the updated assessment data and the second set of anomalies. The second anomaly data is indicative of at least a second reason of the set of reasons for the occurrence of each anomaly within the second set of anomalies. Further, the program instructions executable by the processor set to cause the processor set to apply the second AI model on the second anomaly data, the second set of anomalies, and the updated assessment data. Furthermore, the program instructions executable by the processor set to cause the processor set to generate a second set of recommendations of the set of recommendations based on the application of the second AI model on the second anomaly data, the second set of anomalies, and the updated assessment data. The second set of recommendations is generated to resolve the second set of anomalies. The program instructions executable by the processor set to cause the processor set to output the second anomaly data, and the second set of recommendations.

In some embodiments of the disclosure, the second reason includes at least one of an occurrence of one or more logical flaws in the at least one updated response, or an absence of at least one section of data in the at least one updated response.

According to one or more embodiments of the disclosure, a computer program product for detection and management of anomalies in assessment data is described. The computer program product includes one or more computer-readable storage medium and program instructions stored on the one or more computer-readable storage media to perform operations. The operations include receiving assessment data associated with a first entity. The assessment data includes at least a set of questions and a first set of responses for the set of questions. The set of questions is associated with an evaluation of the first entity conducted by a second entity about an operational activity. The operations further include detecting a first set of anomalies in the assessment data based on one or more risk parameters associated with the first entity and a set of logic rules. The set of logic rules is rules associated with the assessment data to evaluate an integrity of the assessment data, an accuracy of the assessment data, and compliance of the assessment data. Further, the operations include generating anomaly data associated with the first set of anomalies based on the assessment data and the first set of anomalies. The anomaly data is indicative of a set of reasons for an occurrence of each anomaly of the first set of anomalies in the assessment data. The operations further include generating a set of recommendations based on the anomaly data, the first set of anomalies, and the assessment data. The set of recommendations is generated to resolve the first set of anomalies. The operations further include outputting the anomaly data and the set of recommendations.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

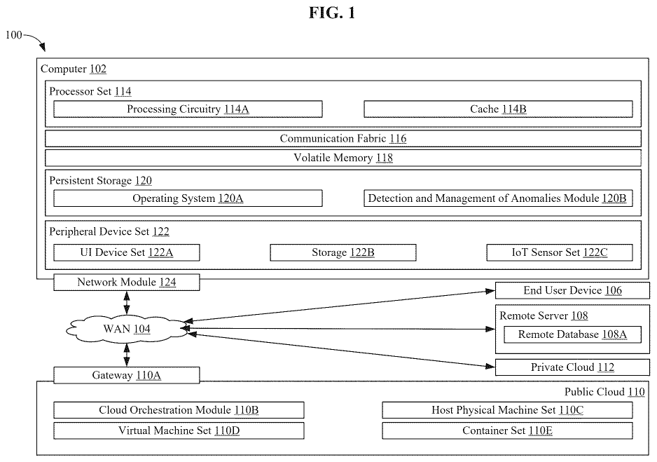

FIG. 1 is a diagram that illustrates a computing environment 100 for the detection and management of anomalies in assessment data, in accordance with an embodiment of the disclosure. With reference to FIG. 1, there is shown a computing environment 100 that contains an example of an environment for the execution of at least some of the computer code/module involved in performing the disclosed methods, such as detection and management of anomalies module 120B. In addition to the detection and management of anomalies module 120B for the detection and management of anomalies in the assessment data, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the detection and management of anomalies module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch, a robot, or other wearable computer, a mainframe computer, a quantum computer, or any other form of a computer or a mobile device now known or to be developed in the future that is capable of running a program, accessing a network or querying a database, such as a remote database 108A. As is well understood in the art of computer technology, and depending upon the technology, the performance of a computer-implemented method is distributed among multiple computers and/or between multiple locations. On the other hand, in this presentation of the computing environment 100, detailed discussion is focused on a single computer, specifically the computer 102, to keep the presentation as simple as possible. The computer 102 is located in a cloud, even though it is not shown in a cloud in FIG. 1. On the other hand, computer 102 is not required to be in a cloud except to any extent as is affirmatively indicated.

The processor set 114 includes one, or more, computer processors of any type now known or to be developed in the future. The processing circuitry 114A is distributed over multiple packages, for example, multiple, coordinated integrated circuit chips. The processing circuitry 114A may implement multiple processor threads and/or multiple processor cores. The cache 114B is a memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 is located “off-chip.” In some computing environments, the processor set 114 is designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in several types of computer-readable storage media, such as the cache 114B and the other storage media discussed below. The program instructions, and associated data, are accessed by the processor set 114 to control and direct the performance of the disclosed methods. In computing environment 100, at least some of the instructions for performing the disclosed methods are stored in the dynamic modification of the detection and management of anomalies module 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Other types of signal communication paths are used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to computer 102, but alternatively or additionally, the volatile memory 118 is distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 is a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the detection and management of anomalies module 120B typically includes at least some of the computer code involved in performing the disclosed methods.

The peripheral device set 122 includes the set of peripheral devices of computer 102. Data communication connections between the peripheral devices and the other components of computer 102 are implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, storage 122B may take the form of a quantum computing storage device for storing data in the form of qubits. In embodiments of the disclosure where computer 102 is required to have a large amount of storage (for example, where computer 102 locally stores and manages a large database) then this storage is provided by peripheral storage devices designed for storing very large amounts of data, such as a storage area network (SAN) that is shared by multiple, geographically distributed computers. The IoT sensor set 122C is made up of sensors that can be used in Internet of Things applications. For example, one sensor is a thermometer, and another sensor is a motion detector.

The network module 124 is the collection of computer software, hardware, and firmware that allows computer 102 to communicate with other computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In some embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 is replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 is a client device, such as a thin client, heavy client, mainframe computer, desktop computer, and so on.

The remote server 108 is any computer system that serves at least some data and/or functionality to the computer 102. The remote server 108 is controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data is provided to the computer 102 from the remote database 108A of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs are stored as images and are transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in some embodiments of the disclosure, a private cloud is disconnected from the internet entirely and only accessible through a local/private network. A hybrid cloud is a composition of multiple clouds of diverse types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

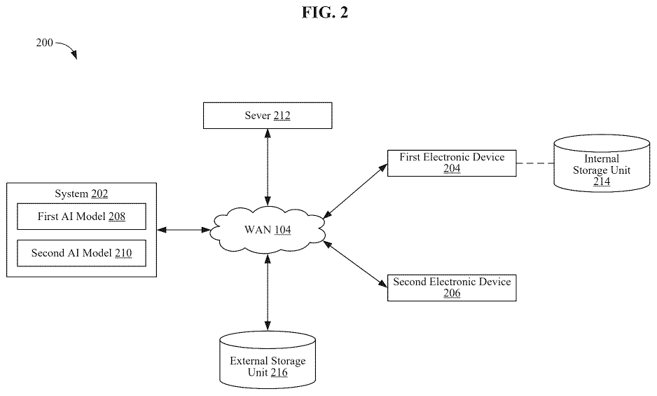

FIG. 2 is a diagram that illustrates a network environment 200 for the detection and management of the anomalies, in accordance with an embodiment of the disclosure. FIG. 2 is explained in conjunction with elements from FIG. 1. The network environment 200 includes a computer system 202 (also referred as system 202), a first electronic device 204, a second electronic device 206, and an Artificial Intelligence (AI) engine including a first AI model 208, and a second AI model 210. Further, the network environment 200 also includes a server 212 and a storage unit, such as an internal storage unit 214 and an external storage unit 216. The network environment 200 further includes a WAN 104 of FIG. 1. In an embodiment of the disclosure, the system 202 is an exemplary embodiment of the computer 102 in FIG. 1.

In an embodiment of the disclosure, each of the first electronic device 204 associated with a first entity, and the second electronic device 206 associated with a second entity is connected independently to the system 202 using the WAN 104, such as 5G, 6G, and future wireless networks. This individual connectivity facilitates seamless and efficient data exchange between the system 202 and each of the first electronic device 204 and the second electronic device 206, allowing for real-time communication and the timely updating of assessment data. By leveraging advanced wireless technologies such as 5G, 6G, and future networks, the system 202 can accommodate high data throughput and low latency, ensuring that users on both the first electronic device 204 and the second electronic device 206 can access and respond to anomalies and recommendations without delays.

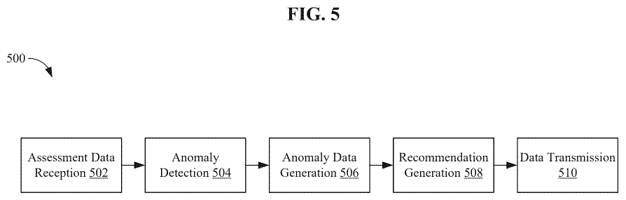

In an embodiment of the disclosure, the first entity corresponds to an organization, or an individual being evaluated in relation to their operational activities. The first entity is the subject of the assessment process, which involves evaluating its security posture, compliance, and risk factors. For example, the first entity may be a company seeking to establish a vendor relationship or a business undergoing a security audit. Further, the second entity represents an organization or an individual that evaluates or interacts with the first entity. The second entity may include external auditors, regulatory bodies, or clients who evaluate the first entity's compliance and security practices. The second entity may provide feedback, responses, or recommendations based on the assessment data collected from the first entity. In an embodiment of the disclosure, the assessment data includes at least a set of questions and a first set of responses for the set of questions. The set of questions is associated with the evaluation of the first entity conducted by a second entity about an operational activity. In an embodiment of the disclosure, the operational activity is performed by the first entity. In an example, the assessment data may include information relevant to assessing the first entity's operational activity, such as security practices, compliance status, risk parameters, and the like. The assessment data is crucial for identifying anomalies, determining risk levels, and generating recommendations for improvement. In an embodiment of the disclosure, the anomalies refer to deviations or irregularities identified within the assessment data that may indicate potential issues or risks. For example, the anomalies may be inconsistencies, errors, or unexpected patterns in the assessment data provided by the first entity. Details on the first entity, the second entity, and the operational activity have been explained with reference to, for example, FIG. 5.

The system 202 may include suitable logic, circuitry, interfaces, and/or code that is configured for the detection and management of the anomalies. The system 202 is configured to receive the assessment data associated with the first entity. The system 202 is further configured to detect a first set of anomalies in the assessment data based on one or more risk parameters associated with the first entity and a set of logic rules. In an embodiment of the disclosure, the first set of anomalies corresponds to a set of issues detected within the assessment data. As an example, the set of issues may include incomplete or missing data in the assessment data. As an additional example, if the assessment data requires participants to provide feedback on multiple aspects of a service but some participants skipped this question, the resulting assessment data may be considered as incomplete. The set of issues may also include inconsistent data, which can arise when responses of the participants vary significantly for similar questions or when different participants interpret questions differently. The set of issues may also include incorrect data formatting. The incorrect data formatting occurs when the participants enter data in an unexpected format, such as providing text instead of numerical values or using inconsistent date formats. The incorrect data formatting can complicate data analysis and lead to erroneous conclusions.

In an embodiment of the disclosure, the first set of anomalies may include data integrity anomalies, compliance anomalies, cybersecurity anomalies, operational anomalies, and the like. The data integrity anomalies occur when the assessment data does not meet expected standards of accuracy or completeness. The compliance anomalies arise when the assessment data fails to adhere to regulatory or organizational standards. For example, if a vendor's response times to security incidents are usually within a standard range (e.g., 24-48 hours), but a recent incident took over a week to address, this deviation from the regulatory standard may be flagged as an anomaly. This may suggest issues with the vendor's incident response capabilities or resource allocation. Further, cybersecurity anomalies may include unusual patterns of access to sensitive data or systems. For example, if a vendor reports a low number of phishing attempts (e.g., 1-2 incidents per month), but suddenly reports 15 incidents in a single month, this spike may be considered an anomaly. Such a significant increase may indicate a potential security breach or a failure in the vendor's security protocols, warranting further investigation. Furthermore, operational anomalies refer to unexpected behaviours in operational activities. For example, a manufacturing entity reporting a sudden spike in defect rates. The first AI model may identify the sudden spike as an anomaly by comparing current performance metrics of the manufacturing entity against historical data of the manufacturing entity.

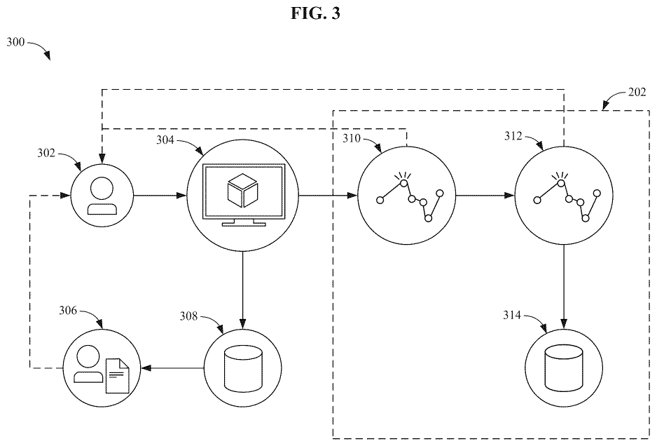

In an embodiment of the disclosure, the set of logic rules is rules associated with the assessment data to evaluate an integrity of the assessment data, an accuracy of the assessment data, and compliance of the assessment data. Details on the one or more risk parameters and detecting the first set of anomalies in the assessment data have been explained with reference to, for example, FIG. 3 and FIG. 5.

The system 202 is further configured to generate anomaly data associated with the first set of anomalies based on the assessment data and the first set of anomalies. In an embodiment of the disclosure, the anomaly data is indicative of a set of reasons for an occurrence of each anomaly of the first set of anomalies in the assessment data. Further, the system 202 is configured to generate a set of recommendations based on the anomaly data, the first set of anomalies, and the assessment data. In an embodiment of the disclosure, the set of recommendations is generated to resolve the first set of anomalies. Furthermore, the system 202 is configured to output the anomaly data and the set of recommendations. Details on the determination of the anomaly data, the set of reasons, and the generation of the set of recommendations have been explained with reference to, for example, FIG. 5.

Further, the first electronic device 204 includes suitable logic, circuitry, interfaces, and/or code configured to input and transmit the assessment data to the system 202, which involves completing the set of questions related to the operational activity of the first entity. The first electronic device 204 also facilitates data updates, allowing the first entity to update the assessment data based on the set of recommendations provided by the system 202, thereby ensuring that the information remains accurate and current. In addition to data input and updates, the first electronic device 204 displays detected anomalies, enabling users to understand potential issues within the assessment data. This visibility allows for informed decision-making and timely responses. The first electronic device 204 also provides a platform for users to review and evaluate the set of recommendations generated by the system 202 to address identified anomalies. By facilitating interaction between users (such as assessors and compliance officers), and the system 202, the first electronic device 204 enhances user experience and engagement in managing assessment data and anomalies. Further, the first electronic device 204 ensures efficient communication with the system 202 through connectivity technologies like WAN, thereby supporting timely and secure data exchange. The first electronic device 204 is communicatively coupled with the system 202 via the WAN. In an embodiment of the disclosure, the first electronic device 204 is an exemplary embodiment of the EUD 106. Examples of the first electronic device 204 may include, but are not limited to, a computing device, a smartphone, a mainframe machine, a server, a computer work-station, a cellular phone, a mobile phone, a gaming device, a consumer electronic (CE) device, a head-mounted device, a Virtual Reality (VR) Headset, an Augmented Reality (AR) Device, a Mixed Reality (MR) Device, a Projection-based System, and/or any other electronic device. In an embodiment of the disclosure, the system 202 is implemented in the server 212. In an embodiment of the disclosure, the system 202 is implemented in the first electronic device 204, the second electronic device 206, or a combination thereof.

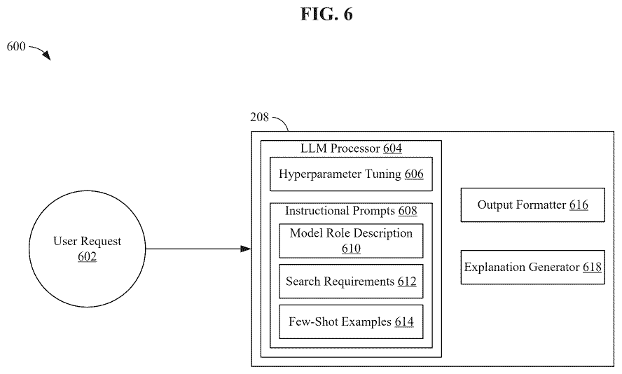

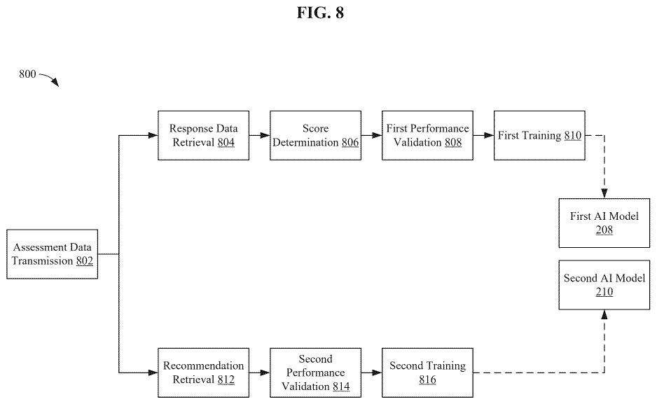

In an embodiment of the disclosure, the second electronic device 206 is used by the second entity to provide real-time evaluation and analysis of the assessment data pertaining to the first entity's operational activity. Further, the second electronic device 206 facilitates the collection and relay of the information required for determining a performance score of the first AI model 208, which assesses the effectiveness of the first AI model 208 in identifying the first set of anomalies. By leveraging the response data obtained via the second electronic device 206, the system 202 can validate the AI model's performance against a threshold, ensuring its accuracy and reliability in anomaly detection. Furthermore, the second electronic device 206 supports ongoing training and refinement of the first AI model 208, enhancing the capabilities of the first AI model 208 through iterative learning based on the evaluations provided by the second entity. Details on the training of the AI model have been explained with reference to, for example, FIG. 5, FIG. 6, and FIG. 8.

In an embodiment of the disclosure, a display screen of the first electronic device 204 may include suitable logic, circuitry, and interfaces configured to display the assessment data. Further, the display screen provides a user-friendly interface where the first entity can easily access the set of questions related to their operational activities, allowing for efficient data input and engagement with the assessment process. The display screen visually conveys real-time feedback, highlighting any detected anomalies and their corresponding recommendations generated by the system 202. The display screen not only facilitates the input of responses but also enhances the understanding of the integrity and accuracy of the assessment data. In an embodiment of the disclosure, the display screen may refer to a display screen of a smartphone, a display screen of a laptop, a display screen of a desktop computer, a display screen of head-mounted device (HMD), a display screen of a smart-glass device, a see-through display, a projection-based display, an electro-chromic display, or a transparent display. In an embodiment of the disclosure, the display screen is realized through several known technologies such as, but are not limited to, a Liquid Crystal Display (LCD) display, a Light Emitting Diode (LED) display, a plasma display, or an Organic LED (OLED) display technology, or other display devices.

In an embodiment of the disclosure, each of the first AI model 208 and the second AI model 210 is a computational network or a system of artificial neurons, arranged in a plurality of layers, as nodes. The plurality of layers of each of the first AI model 208 and the second AI model 210 includes an input layer, one or more hidden layers, and an output layer. Each layer of the plurality of layers includes one or more nodes (or artificial neurons). Outputs of all nodes in the input layer are coupled to at least one node of hidden layer(s). Similarly, inputs of each hidden layer are coupled to outputs of at least one node in other layers of the first AI model 208 and the second AI model 210. Outputs of each hidden layer are coupled to inputs of at least one node in other layers of the first AI model 208 and the second AI model 210. Node(s) in the final layer receive inputs from at least one hidden layer to output a result. The number of layers and the number of nodes in each layer are determined from the hyper-parameters of each of the first AI model 208 and the second AI model 210. Such hyper-parameters are set before or while training the first AI model 208 and the second AI model 210 on a training dataset.

Each node of each of the first AI model 208 and the second AI model 210 may correspond to a mathematical function (e.g., a sigmoid function or a rectified linear unit) with a set of parameters, tunable during the training of the network. The set of parameters includes, for example, a weight parameter, a regularization parameter, and the like. Each node uses the mathematical function to compute an output based on one or more inputs from nodes in other layer(s) (e.g., previous layer(s)) of the first AI model 208 and the second AI model 210. All or some of the nodes of each of the first AI model 208 and the second AI model 210 may correspond to the same or a different mathematical function.

In training the first AI model 208 and the second AI model 210, one or more parameters of each node of each of the first AI model 208 and the second AI model 210 are updated based on whether an output of the final layer for a given input (from the training dataset) matches a correct result based on a loss function for the first AI model 208 and the second AI model 210. The above process is repeated for the same or a different input until a minima of loss function is achieved, and a training error is minimized. Several methods for training are known in the art, for example, gradient descent, stochastic gradient descent, batch gradient descent, gradient boost, meta-heuristics, and the like.

The first AI model 208 and the second AI model 210 include electronic data, such as, for example, a software program, code of the software program, libraries, applications, scripts, or other logic or instructions for execution by a processing device, such as a processor set. The first AI model 208 and the second AI model 210 include code and routines configured to enable a computing device, such as the system 202, to perform one or more operations. Additionally, the first AI model 208 and the second AI model 210 are implemented using hardware including a processor, a microprocessor (e.g., to perform or control performance of the one or more operations), a field-programmable gate array (FPGA), or an application-specific integrated circuit (ASIC). Alternatively, in some embodiments, the first AI model 208 and the second AI model 210 are implemented using a combination of hardware and software. Although in FIG. 2, each of the first AI model 208 and the second AI model 210 is shown to be integrated within the system 202, the disclosure is not so limited, and each of the first AI model 208 and the second AI model 210 can be a separate entity from the system 202. In an embodiment, each of the first AI model 208 and the second AI model 210 is stored in the server 212. Examples of the first AI model 208 and the second AI model 210 may include, but are not limited to, a deep neural network (DNN), a convolutional neural network (CNN), a CNN-recurrent neural network (CNN-RNN), an artificial neural network (ANN), a fully connected neural network, and/or a combination of such networks.

In an embodiment of the disclosure, the server 212 is implemented as a cloud server and may execute operations through web applications, cloud applications, HTTP requests, repository operations, file transfer, and the like. Other example implementations of the server 212 include, but are not limited to, a database server, a file server, a web server, a media server, an application server, a mainframe server, or a cloud computing server.

In an embodiment of the disclosure, the server 212 is implemented as a plurality of distributed cloud-based resources by use of several technologies that are well known to those ordinarily skilled in the art. A person with ordinary skill in the art will understand that the scope of the disclosure may not be limited to the implementation of the server 212 and the system 202 as two separate entities. In certain embodiments, the functionalities of the server 212 can be incorporated in its entirety or at least partially in the system 202, without a departure from the scope of the disclosure.

In an embodiment, each of the internal storage unit 214 and the external storage unit 216 corresponds to a storage unit configured to store an organized collection of data. The organized collection of data can be accessed electronically from a computer system (such as the system 202). In an embodiment, the internal storage unit 214 is communicatively coupled to the first electronic device 204. The internal storage unit 214 is configured to store various types of data related to the assessment process. The internal storage unit 214 securely stores historical assessment data, including the set of questions and corresponding responses from the first entity, allowing for easy retrieval and analysis over time. Additionally, the internal storage unit 214 includes anomaly data generated from the evaluation of the assessment results, detailing the identified anomalies and their potential reasons. Further, the external storage unit 216 is communicatively coupled to the system 202 via the WAN 104. In an embodiment of the disclosure, the external storage unit 216 stores data generated by the assessment processes. The external storage unit 216 enhances the system's capacity to archive historical assessment data, including extensive logs of anomalies detected and their resolutions. For example, the external storage unit 216 can store detailed records of past assessments, compliance documentation, and performance evaluation reports of the AI model over time. By leveraging the external storage unit 216, the system 202 can manage larger volumes of data effectively, ensuring that valuable insights and historical context are readily available for ongoing analysis and strategic decision-making. Further, each of the internal storage unit 214 and the external storage unit 216 are designed to manage, store, retrieve, and update data efficiently. The structure of each of the internal storage unit 214 and the external storage unit 216 typically involves tables, records, and fields that can be managed through various database management systems (DBMS). Examples of each of the internal storage unit 214 and the external storage unit 216 unit may include, but are not limited to, a relational database, a Non-Structured Query Language (SQL) database, a hierarchical database, a network database, a transactional database, a data warehouse, a distributed database, and a data lake.

In an embodiment of the disclosure, the server 212 is configured to store each of the first AI model 208 and the second AI model 210 on the internal storage unit 214 or the external storage unit 216.

In operation, the system 202 is configured to receive the assessment data from the first entity, which includes the set of questions and the first set of responses regarding operational activities. For example, if the system 202 asks whether the entity has experienced any data breaches in the past year, the response could indicate “yes,” prompting further investigation. The system 202 is further configured to detect the first set of anomalies using the set of logic rules and the one or more risk parameters, evaluating the assessment data's integrity, accuracy, and compliance. For example, the one or more risk parameters include financial stability indicators of the first entity, a regulatory compliance status of the first entity, security posture metrics of the first entity, an incident history of the first entity, and the like. Further, the system 202 is configured to analyze the first set of anomalies to generate the anomaly data and generate the set of recommendations to address the first set of anomalies. Finally, the system 202 is configured to output the anomaly data and a set of recommendations, providing clear insights for informed decision-making.

FIG. 3 is a diagram that illustrates an environment for depicting a process of detecting and managing the anomalies, in accordance with an embodiment of the disclosure. FIG. 3 is explained in conjunction with elements from FIG. 1, and FIG. 2. With reference to FIG. 3, the diagram 300 represents a comprehensive view of the system 202 designed for the determination and resolution of the anomalies in the assessment data associated with the first entity. Following systems engineering principles, the system 202 is systematically broken down from a high-level perspective to a detailed parts-level algorithm design, ensuring that each component is well-defined and understood. This structured breakdown of the architecture of the system 202 ensures that complexity is managed effectively, potential issues are identified, and overall performance is optimized. The architecture diagram illustrates the logical organization and interactions between components of the system, providing a clear overview of how each part contributes to the system's functionality. By adopting this systematic approach, the architecture facilitates efficient design, implementation, and maintenance of the anomaly detection and resolution process.

With reference to FIG. 3, there is shown a block diagram 300 that illustrates the first entity 302, a risk management platform 304, a cybersecurity assessor 306, a record repository 308, and the system 202. In an embodiment of the disclosure, each of the record repository 308 and the response data repository 314 may be the internal storage unit 214 or the external storage unit 216. In an embodiment of the disclosure, the first entity 302 corresponds to an organization or individual responsible for conducting operational activities and providing the assessment data. For example, the first entity may be a manufacturing company that submits an evaluation of its production processes. The first entity 302 initiates the process by submitting the assessment data to the risk management platform 304 (also called, the third-party supplier risk management platform), which acts as a centralized system for managing and evaluating supplier-related risks. For example, the submission of the assessment data occurs via a Supplier Risk Questionnaire (SRQ). In an embodiment of the disclosure, the SRQ is a structured format used to collect relevant data about potential risks.

Further, the assessment data is stored in the record repository 308. The record repository 308 maintains the final version of the assessment data after any updates by the first entity 302. For instance, if the first entity 302 revises its operational practices, the updated data is saved here for future reference. In an embodiment of the disclosure, the cybersecurity assessor 306 corresponds to an expert or team responsible for evaluating the cybersecurity posture of the first entity 302. For example, the cybersecurity assessor 306 may review the assessment data to identify vulnerabilities or compliance issues related to data security practices. The cybersecurity assessor 306 may provide feedback on the assessment data, which can help refine the evaluation process and improve overall risk management.

In conventional methods, the process was limited to these four components: the first entity 302, the risk management platform 304, the record repository 308, and the cybersecurity assessor 306. However, the introduction of the system 202 now provides the first entity 302 with real-time feedback for updating the assessment data. This enhancement allows the first entity 302 to improve the set of responses in the assessment data, ensuring they are complete, correct, and compliant. The system 202 includes a logical engine 310, the AI engine 312, and a response data repository 314.

In an embodiment of the disclosure, the logical engine 310 applies the set of logic rules to the assessment data, enabling the detection of the first set of anomalies based on the one or more risk parameters associated with the first entity 302. The first set of anomalies may include discrepancies in the data, such as missing responses or unusual patterns that deviate from established norms. In an embodiment of the disclosure, the one or more risk parameters correspond to criteria used to evaluate potential security risks associated with the first entity 302. For example, the one or more risk parameters include financial stability indicators of the first entity 302, a regulatory compliance status of the first entity 302, security posture metrics of the first entity, an incident history of the first entity 302, and the like.

Further, the AI engine 312 includes two models, the first AI model 208 and the second AI model 210. The first AI model 208 assesses the first set of anomalies and generates the anomaly data, indicating possible reasons for the occurrence of the first set of anomalies, such as incorrect data formatting or missing responses. The second AI model 210 generates the set of recommendations for resolving the first set of anomalies based on the output of the first AI model 208.

To support the iterative process of assessment and improvement, the system 202 includes the response data repository 314. The response data repository 314 is vital for storing various types of data, including the first set of anomalies, the anomaly, one or more inputs from the first entity 302, and the set of recommendations. For example, if the first entity 302 receives the set of recommendations for improvement of the assessment data and provides feedback, this data is stored in the response data repository 314 to inform future assessments. This collected data not only aids in the immediate resolution of issues but also serves as training data for both the first AI model 208 and the second AI model 210, enhancing their capabilities over time.

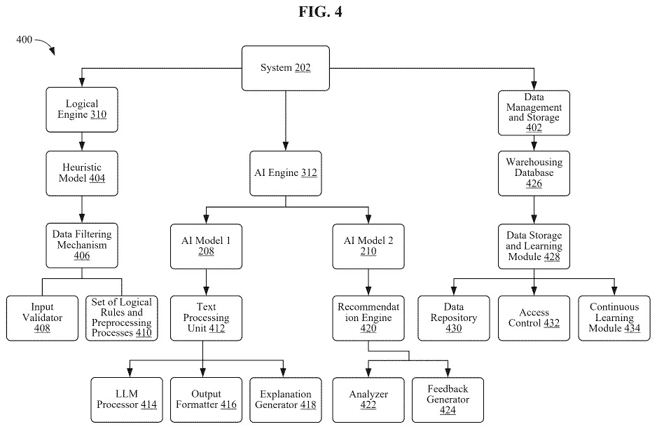

FIG. 4 is a diagram that illustrates a system-level architecture 400 of the system 202 for the detection and management of the anomalies, in accordance with an embodiment of the disclosure. FIG. 4 is explained in conjunction with elements from FIG. 1, FIG. 2, and FIG. 3. The system-level architecture 400 presents a comprehensive tree-like structure for the system 202, designed to enhance the assessment data processing and user feedback mechanisms. The system 202 is organized into several hierarchical levels, each playing a critical role in ensuring the accuracy and quality of the data submitted through the SRQ process.

As shown in FIG. 4, the system 202 is at the topmost level representing the entire end-to-end process that includes SRQ submission and user feedback. This structure is designed to streamline the flow of data while enhancing user interactions. The system 202 is divided into three subsystems i.e., the logical engine 310, the AI engine 312, and a data management and storage 402. In an embodiment of the disclosure, each subsystem of the system 202 is used for processing input data, applying advanced analytical processes, and managing data effectively.

Further, the logical engine 310 is configured to guide the first entity through the SRQ process, especially when errors/anomalies occur. The logical engine 310 enhances the data accuracy at the input stage by implementing the set of logic rules that filter and preprocess the assessment data inputted by the first entity. Furthermore, a heuristic model 404 is connected with the logical engine 310. The heuristic model 404 employs logical gates to streamline the user experience, ensuring high-quality data progression through the system's pipeline. Further, the logical engine 310 performs a data filtering mechanism 406 using an input validator 408, and a set of logical rules and preprocessing processes 410. In an embodiment of the disclosure, the data filtering mechanism 406 corresponds to a systematic approach that processes the assessment data to ensure it meets specific quality standards before proceeding with the evaluation.

Furthermore, the input validator 408 determines the accuracy and completeness of data entries, verifying required fields, ensuring correct formats, and cross-referencing against criteria set by subject matter experts. For example, if a required field for “Email Address” is missing, the input validator 408 prompts the first entity to fill the email address field. Further, the logical engine 310 applies the set of logical rules and preprocessing processes 410 to evaluate the assessment data (i.e., the SRQ) for the first set of anomalies (i.e., logical flaws and information gaps). This step identifies any inconsistencies, such as contradictory answers, and prevents the submission from proceeding until corrections are made.

If the initial data quality passes minimum entry requirements, the next level in processing involves algorithms that evaluate the SRQ for logical flaws and gaps in information. At this stage, the set of logical rules and preprocessing processes 410 are designed to filter and preprocess the data, preventing the propagation of identified logical gaps. If these logical flaws are bypassed, assessors are forced to connect with users for further verification of the information. Therefore, this stage prevents this nuanced inefficiency by identifying these gaps using logical gates, providing immediate feedback to the user, and requiring immediate correction before progressing to the submission stage.

In an embodiment of the disclosure, the AI engine 312 is responsible for processing and analyzing data using advanced text processing algorithms. Further, the AI engine 312 is coupled with two AI models (i.e., the first AI model 208 and the second AI model 210), each contributing to the system's overall functionality. The first AI model 208 processes free-format text associated with the assessment data and evaluates the assessment data based on a set of instructions. For example, an instruction from the set of instructions may specify that the first AI model 208 is required to identify and extract all dates mentioned in the input. If a user submits, “the assessment was completed on Sep. 15, 2023,” the first AI model 208 is instructed to recognize “Sep. 15, 2023” as a relevant date. Further, the first AI model 208 uses a text processing unit 412 configured to analyze and transform raw and unstructured assessment data into a structured format that can be further processed and utilized within the system 202. Further, the text processing unit 412 is connected with a Large Language Model (LLM) processor 414, an output formatter 416, and an explanation generator 418. Details on the first AI model 208 and training of the first AI model 208 have been explained with reference to, for example, FIG. 6 and FIG. 8.

In an embodiment of the disclosure, the LLM processor 414 uses LLMs to analyze and process the assessment data. For example, LLM processor 414 can interpret user inputs in natural language and convert them into structured data. Further, the output formatter 416 transforms processed data into JSON format, a lightweight data-interchange format that is easy to read and write for both humans and machines. Further, the first AI model 208 generates the anomaly data associated with the first set of anomalies. Furthermore, the explanation generator 418 provides one or more reasons behind the generation of the anomaly data. This feature enhances user understanding by clarifying how specific inputs led to certain outputs. For example, if the output of the first AI model 208 indicates that the response related to cybersecurity policies lacks detail, the explanation may state, “the answer provided does not include specific methodologies, such as the types of encryptions used or incident response plans, which are critical for evaluating the organization's risk posture”.

Further, the second AI model 210 serves as a feedback mechanism, offering real-time recommendations based on the structured output from the first AI model 208. The second AI model 210 uses a recommendation engine 420 for enhancing the Supplier Risk Questionnaire (SRQ) process by analyzing the structured outputs generated from the first AI model 208. The recommendation engine 420 uses an analyzer 422 to evaluate the output of the first AI model 208 (i.e., the anomaly data) to identify areas requiring user attention. For example, the analyzer 422 may flag responses that lack detail or contain logical inconsistencies. The recommendation engine 420 also uses a feedback generator 424 to generate and output the set of recommendations to the first entity, such as suggesting rephrasing of answers for clarity or completeness.

Furthermore, the data management and storage 402 component ensures that the processed data (e.g., the anomaly data, the set of recommendations, the first set of anomalies, and the like) is securely stored and accessible for ongoing analysis and learning. The management and storage 402 component uses a warehousing database 426 which serves as a centralized repository for storing all processed data related to the SRQ submissions. The warehousing database 426 stores the anomaly data, the one or more inputs, the set of recommendations, and historical data, enabling efficient data management and retrieval. The data management and storage 402 supports continuous learning by allowing the system 202 to analyze past interactions and improve the accuracy and effectiveness of the AI models (i.e., the first AI model 208 and the second AI model 210) and the overall assessment process.

In an embodiment of the disclosure, the data management and storage 402 component uses a data storage and learning module 428 for securely storing processed data and facilitating continuous learning for the AI models. The data storage and learning module 428 is connected with a data repository 430, an access control 432, and a continuous learning module 434. The data repository 430 stores all processed and raw data, including anonymized responses for continuous improvement. For example, the data repository 430 stores past SRQs to analyze trends and improve the AI models. Further, the access control 432 ensures that only authorized users can access sensitive information, enhancing security and compliance with data protection regulations. Furthermore, the continuous learning module 434 supports the AI models in learning from new data and user feedback (i.e., feedback of the second entity), driving ongoing system enhancement. The continuous learning module 434 ensures that the AI models adapt over time, improving their recommendations and accuracy.

FIG. 5 is a diagram that illustrates exemplary operations for the detection and management of the anomalies, in accordance with an embodiment of the disclosure. FIG. 5 is explained in conjunction with elements from FIG. 1, FIG. 2, FIG. 3, and FIG. 4. With reference to FIG. 5, there is shown a block diagram 500 that illustrates exemplary operations from 502 to 510, as described herein. The exemplary operations illustrated in the block diagram 500 start at 502 and are performed by any computing system, apparatus, or device, such as by the computer 102 of FIG. 1 or system 202 of FIG. 2. Although illustrated with discrete blocks, the exemplary operations associated with one or more blocks of the block diagram 500 are divided into additional blocks, combined into fewer blocks, or eliminated, depending on the particular implementation.

At 502, an assessment data reception operation is executed. In the assessment data reception operation, the system 202 is configured to receive the assessment data associated with the first entity. In an embodiment of the disclosure, the system 202 receives the assessment data from the first entity (e.g., the vendor) via one or more means, such as an online form or via direct uploads, thereby initiating the assessment process. For example, the assessment data refers to the Security Risk Questionnaire (SRQ) data collected from the vendor. The SRQ consists of structured information aimed at evaluating the vendor's security practices, risk management strategies, and compliance with relevant standards. The SRQ provides a comprehensive overview of the vendor's operational risk profile. In an embodiment of the disclosure, the assessment data includes at least one of the set of questions, or the first set of responses for the set of questions. Further, the set of questions is associated with the evaluation of the first entity conducted by a second entity about the operational activity. In an embodiment of the disclosure, the operational activity is performed by the first entity. For example, the operational activity encompasses multiple functions and tasks that the vendor performs during its business operations. Evaluating the multiple functions and tasks through the SRQ helps to evaluate the vendor's effectiveness in managing security risks and compliance issues.

At 504, an anomaly detection operation is executed. In the anomaly detection operation, the system 202 is configured to detect the first set of anomalies in the assessment data based on the one or more risk parameters associated with the first entity and the set of logic rules. In an embodiment of the disclosure, the set of logic rules is rules associated with the assessment data to evaluate an integrity of the assessment data, an accuracy of the assessment data, and compliance of the assessment data. For example, a logic rule may specify that if a vendor reports a certain level of data security, then their response to related questions must reflect that same level of diligence. In an embodiment of the disclosure, the first set of anomalies corresponds to specific irregularities or unexpected patterns detected within the assessment data. The first set of anomalies may indicate potential risks, inaccuracies, or areas where the vendor's responses do not align with established risk parameters or best practices. For example, if a vendor claims to have robust data protection measures but simultaneously indicates that sensitive data is stored without encryption, this inconsistency may constitute an anomaly. In an embodiment of the disclosure, the one or more risk parameters correspond to criteria used to evaluate potential security risks associated with the first entity. For example, the one or more risk parameters include financial stability indicators of the first entity, a regulatory compliance status of the first entity, security posture metrics of the first entity, an incident history of the first entity, and the like.

For the detection of the first set of anomalies, the system 202 is configured to apply a first set of logic rules of the set of logic rules to the assessment data. Further, the system 202 is configured to detect the first set of anomalies in the assessment data based on the one or more risk parameters and the application of the first set of logic rules to the assessment data.

At 506, an anomaly data generation operation is executed. In the anomaly data generation operation, the system 202 is configured to generate the anomaly data associated with the first set of anomalies based on the assessment data and the first set of anomalies. In an embodiment of the disclosure, the anomaly data is indicative of a set of reasons for an occurrence of each anomaly of the first set of anomalies in the assessment data. For example, if an anomaly indicates that a vendor reported no security incidents, but their risk profile suggests otherwise, the anomaly data may highlight this contradiction.

For the generation of the anomaly data, the system 202 is configured to apply the first AI model 208 on the assessment data and the first set of anomalies. The system 202 is configured to generate first anomaly data of the anomaly data based on the application of the first AI model 208 on the assessment data and the first set of anomalies. In an embodiment of the disclosure, the first anomaly data is indicative of at least a first reason of the set of reasons for the occurrence of each anomaly within the first set of anomalies. In an example, the first reason is associated with at least one of an absence of at least one response in a first set of responses, an occurrence of incorrect data formatting in the first set of responses, or an occurrence of a set of errors associated with a first set of criteria for the first set of responses.

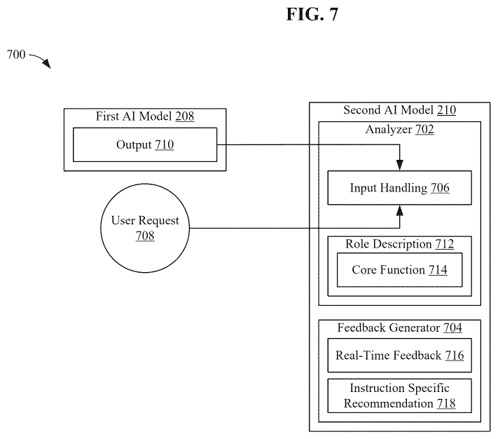

At 508, a recommendation generation operation is executed. In the recommendation generation operation, the system 202 is configured to generate the set of recommendations based on the anomaly data, the first set of anomalies, and the assessment data. In an embodiment of the disclosure, the set of recommendations is generated to resolve the first set of anomalies. For the generation of the set of recommendations, the system 202 is configured to apply the second AI model 210 on the first anomaly data, the first set of anomalies, and the assessment data. Further, the system 202 is configured to generate a first set of recommendations of the set of recommendations based on the application of the second AI model 210 on the first anomaly data, the first set of anomalies, and the assessment data. In an embodiment of the disclosure, the first set of recommendations is generated to resolve the first set of anomalies detected in the assessment data. For example, if an anomaly is identified due to a missing response, a recommendation may suggest the first entity to complete the missing information to ensure a comprehensive evaluation. Details on the second AI model 210 have been explained with reference to, for example, FIG. 7 and FIG. 8.

At 510, a data transmission operation is executed. In the data transmission operation, the system 202 is configured to output the anomaly data and the set of recommendations. For example, the output is presented visually on a display screen of the first electronic device 204 used by the first entity. The display screen may include graphical elements, such as charts or highlighted text, to draw attention to critical issues and facilitate the vendor's decision-making process.

In an embodiment of the disclosure, the system 202 is configured to receive the one or more inputs from the first electronic device 204 associated with the first entity to update the assessment data. The one or more inputs are received based on the outputting of the first set of recommendations on the first electronic device 204. Further, the system 202 is configured to update the assessment data based on the one or more inputs. In an embodiment of the disclosure, the updated assessment data includes at least one updated response associated with the first set of responses. For example, if the first entity i.e., the vendor originally failed to provide documentation of safety procedures, the vendor may now upload the required documentation as an updated response to the set of recommendations, resulting in the updated assessment data that reflects this new compliance evidence. The system 202 is further configured to apply a second set of logic rules of the set of logic rules to the updated assessment data. Furthermore, the system 202 is configured to detect a second set of anomalies in the updated assessment data based on the application of the second set of logic rules to the updated assessment data. For example, the second set of anomalies may correspond to issues like missing information in the newly submitted documentation or inconsistencies between the vendor's claims and previous assessments. The system 202 is configured to output the second set of anomalies.

Further, the system 202 is configured to apply the first AI model 208 on the updated assessment data and the second set of anomalies. The system 202 is further configured to generate the second anomaly data of the anomaly data based on the application of the first AI model 208 on the updated assessment data and the second set of anomalies. In an embodiment of the disclosure, the second anomaly data is indicative of at least a second reason of the set of reasons for the occurrence of each anomaly within the second set of anomalies. In an embodiment of the disclosure, the second reason includes at least one of an occurrence of one or more logical flaws in the at least one updated response, or an absence of at least one section of data in the at least one updated response. Further, the system 202 is configured to apply the second AI model 210 on the second anomaly data, the second set of anomalies, and the updated assessment data. Furthermore, the system 202 is configured to generate a second set of recommendations of the set of recommendations based on the application of the second AI model 210 on the second anomaly data, the second set of anomalies, and the updated assessment data. In an embodiment of the disclosure, the second set of recommendations is generated to resolve the second set of anomalies. The system 202 is configured to output the second anomaly data, and the second set of recommendations. For example, the vendor XYZ updates the assessment data, and the second AI model 210 analyzes the at least one updated response in the updated assessment data to identify issues, such as incomplete information or unclear documentation. The system 202 then generates the second set of recommendations, such as enhancing the clarity of responses, providing additional supporting documents, and revising specific sections to meet compliance standards. The second set of recommendations further improves the quality of the vendor's submissions based on the updated assessment data.

FIG. 6 is a diagram that illustrates a system-level architecture 600 of the first AI model 208, in accordance with an embodiment of the disclosure. FIG. 6 is explained in conjunction with elements from FIG. 1, FIG. 2, FIG. 3, FIG. 4, and FIG. 5. The AI engine 312 is a subsystem of the system 202 configured to process and analyze data through advanced text processing algorithms. The AI engine 312 includes two AI models i.e., the first AI model 208 and the second AI model 210, which work together to ensure accurate and meaningful outputs from user submissions i.e., the assessment data. Further, the output from the logical engine 310 serves as the input for these two AI models, allowing them to generate structured responses based on the initial unstructured data. With reference to FIG. 6, there is shown an exemplary diagram of the system-level architecture 600 of the first AI model 208.

In an embodiment of the disclosure, the system-level architecture of the first AI model 208 is an integral component of the system-level architecture, designed to enhance the processing and analysis of the assessment data (i.e., the set of questions and the set of responses submitted by vendors in the SRQ. The system-level architecture 600 is structured to facilitate accurate and meaningful outputs while allowing seamless integration with third-party security platforms. The first AI model 208 is trained to prepare and prime the output for the second AI model 210. The first AI model 208 is designed to accept free-format text from vendor submissions, evaluate decision-making based on model-specific instructions, and convert the results into a structured JSON format using output formatter's instructions. This transformation is vital for facilitating further analysis in the second AI model 210. The first AI model 208 employs a large language model to comprehend and process text data effectively. The first AI model 208 can be integrated across various third-party security platforms, allowing users to customize and align the first AI model 208 with their specific business needs.

The system-level architecture of the first AI model 208 begins with a block user request 602, which encapsulates the assessment data including the set of questions and the set of responses received from the first entity. The assessment data is used for evaluating the compliance and operational effectiveness of the first entity. Further, the first AI model 208 includes a Large Language Model (LLM) processor 604 (for example, LLM processor 414 of FIG. 4), which leverages natural language processing capabilities to interpret and evaluate free-format text. The LLM processor 604 is vital for transforming raw input into structured outputs. The LLM processor 604 is further divided into two key functionalities i.e., hyperparameter tuning 606 and instructional prompts 608. The hyperparameter tuning 606 is a process that optimizes the performance of the first AI model 208 on specific tasks related to SRQ data processing. This tuning ensures that the first AI model 208 can adapt and enhance its evaluation capabilities according to the unique requirements of different assessments. For example, if the assessment data frequently includes incomplete responses, the hyperparameter tuning 606 adjusts the AI model's parameters to prioritize identifying and flagging these gaps in the future.

Further, the instructional prompts 608 guide the generative capabilities of the LLM. The instructional prompts 608 include a model role description 610, search requirements 612, and few-shot examples 614. The model role description 610 clearly defines the purpose of the first AI model 208, which is to prepare the data for the second AI model 210 by converting unstructured text into a structured JavaScript Object Notation (JSON) format. Further, the search requirements 612 specify key elements to be extracted, ensuring that relevant information is highlighted during processing. For example, identifying compliance-related keywords in the vendor's responses. The few-shot examples 614 provide the first AI model 208 with examples of both high-quality and low-quality responses helping the model distinguish between high-quality and low-quality data. For instance, if a vendor provides incomplete financial data, the first AI model 208 may use these examples to identify the deficiency and flag it for review. This enables the first AI model 208 to differentiate effective answers from ineffective answers, enhancing the ability of the first AI model 208 to generate useful output.

Further, the first AI model 208 includes an output formatter 616 (for example, output formatter 416 of FIG. 4) configured to structure the processed data. After the first AI model 208 has analyzed the input text, the output formatter 616 converts the findings into the JSON format, which can be easily used by the second AI model 210. For example, if a vendor's response indicates a lack of documentation, the output formatter 616 may structure this observation into a clear, machine-readable format, outlining the specific deficiencies. The first AI model 208 also includes an explanation generator 618 (for example, explanation generator 418 of FIG. 4) configured to provide detailed descriptions of vendor-specific information based on decision criteria. This component allows stakeholders to understand why certain recommendations are made. For instance, if a recommendation is to provide additional financial documentation, the explanation generator 618 may clarify that this is due to identified gaps in the vendor's financial stability indicators.

FIG. 7 is a diagram that illustrates a system-level architecture 700 of the second AI model 210, in accordance with an embodiment of the disclosure. FIG. 7 is explained in conjunction with elements from FIG. 1, FIG. 2, FIG. 3, FIG. 4, FIG. 5, and FIG. 6. The system-level architecture of the second AI model 210 is designed to enhance the assessment process by providing real-time feedback and actionable recommendations to users i.e., the first entity based on the output from the first AI model 208 and the initial user submissions (i.e., the assessment data). The system-level architecture includes multiple key components, such as an analyzer 702 block (for example, analyzer 422 of FIG. 4) and a feedback generator 704 block (for example, feedback generator 424 of FIG. 4).

The system-level architecture begins with an input handling 706 algorithm within the analyzer 702 block. The input handling 706 algorithm is responsible for receiving inputs from two primary sources i.e., a user request 708, which includes the assessment data (the set of questions and the set of responses) and an output 710 from the first AI model 208, which provides a preliminary evaluation of the assessment data. The input handling 706 algorithm ensures that the second AI model 210 can appropriately interpret both the user submissions and the output 710 from the first AI model 208. Further, the input handling 706 algorithm sets the stage for determining whether the assessment data meets the criteria established for successful submissions.

The analyzer 702 block plays a critical role in evaluating the submitted assessment data. The core functionality of the analyzer 702 block is defined by a role description 712. The role description 712 includes a core function 714, which specifies the primary application of the analyzer 702 block i.e., to evaluate the output 710 from the first AI model 208 and determine if they align with the standards set for human review. In an embodiment of the disclosure, instructional prompting mechanisms (i.e., prompts) guide the evaluation process of the second AI model 210 by outlining the expected criteria for the assessment data, such as accuracy, completeness, and compliance with established guidelines. Further, a few-shot priming process is used which involves using examples of both acceptable and unacceptable submissions to help the second AI model 210 quickly learn to identify discrepancies, gaps, or errors in user responses. By leveraging prior examples, the second AI model 210 can better evaluate new submissions against recognized standards.

Further, the feedback generator 704 block includes two blocks i.e., Real-Time Feedback (RTF) 716 block and Instruction-Specific Recommendations (ISM) 718 block to provide users with timely and effective guidance. The RTF 716 block generates immediate feedback based on the analysis conducted by the analyzer 702 block. Further, the RTF 716 block highlights specific areas where the user's submission may be lacking or incorrect. For example, if a user's response fails to provide sufficient documentation or clarity, the RTF 716 block may pinpoint these issues in real time, enabling the user to adjust the assessment data before the final submission. The ISM 718 block provides detailed instructions on how users can modify their submissions for successful processing. Further, the ISM 718 block provides examples and step-by-step guidance, empowering users to understand precisely what changes are required. For example, if the submission lacks certain required fields, the ISM 718 block may outline what those fields are and provide illustrative examples of correctly filled submissions.

The interplay between the analyzer 702 block and feedback generator 704 block is designed to improve the overall user experience by providing real-time actionable insights and recommendations, while simultaneously improving workflow efficiency by minimizing errors in the submissions and streamlining the submission process. By providing real-time and dynamic insights into required modifications, the second AI model 210 helps ensure that submissions are refined before reaching human assessors for final review. This two-step feedback mechanism not only enhances the quality of data collected but also reduces the likelihood of rework and delays in the evaluation process. By facilitating this iterative review process (i.e., two-step feedback mechanism), the system 202 minimizes the likelihood of rework and delays that arise from inadequate or incorrect submissions. As users receive targeted guidance to correct their inputs before final submission, the overall integrity of the data is improved, leading to higher quality assessments. This streamlined approach not only accelerates the evaluation process but also optimizes processing capabilities of the system 202 by reducing the computational overhead associated with handling erroneous submissions and subsequent corrections, thereby enhancing throughput and operational efficiency in data processing workflows.

In an exemplary scenario, the user input (i.e., the assessment data) may be “ABC is a server management software that provides a centralized platform for controlling XYZ environment.” The system 202 detects the anomaly and explains the reason for the detection using the first AI model 208. For example, the reason for the detection of the anomaly: “the user request is missing points 1 and 3. The user did not provide information on why the product is being used and how it is being used.” Further, the system 202 also generates the recommendations to resolve the detected anomaly i.e., “reasoning: the revised request will enable a comprehensive understanding of the product's usage and its value to ABC company, thus ensuring accurate assessment and approval, recommendation: revise the user request to include the name of the vendor and provide clear information on why and how the product is being used by the ABC company”.

FIG. 8 is a diagram that illustrates exemplary operations for the training of the first AI model 208 and the second AI model 210, in accordance with an embodiment of the disclosure. FIG. 8 is explained in conjunction with elements from FIG. 1, FIG. 2, FIG. 3, FIG. 4, FIG. 5, FIG. 6, and FIG. 7. With reference to FIG. 8, there is shown a block diagram 800 that illustrates exemplary operations from 802 to 816, as described herein. The exemplary operations illustrated in the block diagram 800 start at 802 and are performed by any computing system, apparatus, or device, such as by the computer 102 of FIG. 1 or system 202 of FIG. 2. Although illustrated with discrete blocks, the exemplary operations associated with one or more blocks of the block diagram 800 are divided into additional blocks, combined into fewer blocks, or eliminated, depending on the particular implementation.

At 802, an assessment data transmission operation is executed. In the assessment data transmission operation, the system 202 is configured to transmit the assessment data to the second electronic device 206 associated with the second entity. In an embodiment of the disclosure, the second entity is responsible for the evaluation of the first entity about the operational activity.

At 804, a response data retrieval operation is executed. In the response data retrieval operation, the system 202 is configured to obtain response data from the second entity based on the transmission of the assessment data to the second electronic device 206. In an embodiment of the disclosure, the response data is indicative of an occurrence of one or more anomalies in the assessment data. For example, if the second entity identifies discrepancies such as missing financial statements or inconsistencies in reported figures, this feedback becomes part of the response data.

At 806, a score determination operation is executed. In the score determination operation, the system 202 is configured to determine a performance score associated with the first AI model 208 based on the response data and the first set of anomalies. In an embodiment of the disclosure, the performance score is associated with the performance of the first AI model 208 for the detection of the first set of anomalies in the assessment data. For example, if the first AI model 208 successfully flagged 80% of the anomalies found by the evaluator, the performance score may be high, indicating strong performance.

At 808, a first performance validation operation is executed. In the performance validation operation, the system 202 is configured to validate the performance of the first AI model 208 based on the performance score and a threshold performance score. For example, the system 202 validates the performance of the first AI model 208 by comparing the performance score with the threshold performance score. If the performance score meets or satisfies the threshold performance score, the system 202 confirms that the first AI model 208 is functioning effectively. For example, if the threshold performance score is set at 75% and the first AI model 208 achieves an 80% performance score, the validation is successful.

At step 810, a first training operation is executed. In the training operation, the system 202 is configured to train the first AI model 208 based on the response data and the first set of anomalies. In an embodiment of the disclosure, the first AI model 208 is trained upon the validation of the performance of the first AI model 208. This training helps the first AI model 208 to learn from its past evaluations and improves its accuracy in future assessments. For instance, if the first AI model 208 learns that certain types of financial anomalies often go unflagged, the first AI model 208 can adjust its parameters to better detect these financial anomalies in subsequent evaluations.

Further, Table 1 is integral to the training process of the first AI model 208, as it allows for a quantitative assessment that combines the output of the first AI model and the output of the human expertise. By analyzing the discrepancies between the evaluations of the first AI model 208 and the scores of the second AI model 210 (alternatively called assessor's), the first AI model 208 can be trained to improve its accuracy and reliability in future assessments. This continuous learning loop ensures that the first AI model 208 evolves based on real-world feedback, ultimately leading to better validation of vendor inputs. As shown in Table 1, the user input corresponds to the assessment data submitted by the vendor through the Security Risk Questionnaire (SRQ). The user input represents the vendor's responses and is crucial for initiating the evaluation process. Further, in model evaluation, the first AI model 208 processes the user input, providing an initial quantitative score. The results of the model evaluation indicate a rejection, with a score of 0, highlighting deficiencies in the user input. Furthermore, the assessor's evaluation corresponds to the evaluation from human assessors, who apply their domain knowledge to review the user input and the findings of the first AI model 208. An assessor score of 0 confirms that the input did not meet standards, reinforcing the rejection of the first AI model 208. If both the first AI model 208 and the assessors provide a score of 0, it indicates a strong correlation in their evaluations, suggesting that the first AI model 208 accurately identifies deficiencies in the user input. This agreement reinforces the reliability of the first AI model 208.

TABLE 1
Standardized input validation using the first AI
model and domain knowledge of the second entity

| | | Model | Assessor | Assessor |
|---|---|---|---|---|
| User Input | Model Evaluation | Score | Evaluation | Score |
| ABC is a server | Results: rejected | 0 | Reject, fails to | 0 |
| management software | Explanation: reason for | | explain why they | |
| that provides a | rejection is that the user | | need product and | |
| centralized platform | did not clearly identify | | how they will use | |
| for controlling XYZ | the reason behind using | | the product/ | |
| environment. | the product. | | service. | |

Further, the assessment data transmission operation i.e., step 802 is executed again for the training of the second AI model 210. Furthermore, at step 812, a recommendation retrieval operation is performed. In the recommendation retrieval operation, the system 202 is configured to obtain one or more recommendations from the second electronic device 206 associated with the second entity to resolve the first set of anomalies. For example, the second entity analyzes the assessment data and identifies specific areas where the vendor's practices fall short of compliance standards, and generates the one or more recommendations.

At step 814, a second performance validation operation is performed. In the second performance validation operation, the system 202 is configured to validate the performance of the second AI model 210 based on the one or more recommendations and the first set of recommendations. In an embodiment of the disclosure, the second AI model 210 evaluates its effectiveness by comparing the first set of recommendations generated based on the original assessment data of the vendor, and the one or more recommendations received from the second entity.

At step 816, a second training operation is performed. In the second training operation, the system 202 is configured to train the second AI model 210 based on the one or more recommendations and the first set of recommendations. In an embodiment of the disclosure, the second AI model 210 is trained upon the validation of the performance of the second AI model 210.

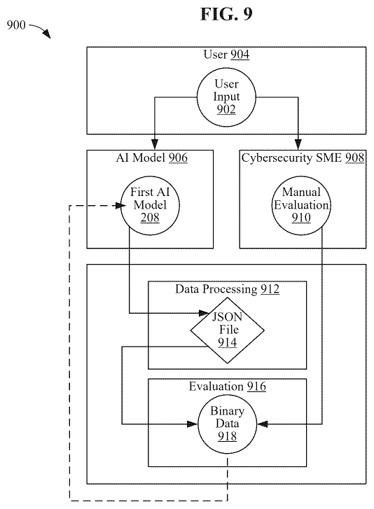

FIG. 9 illustrates a diagram depicting an architecture 900 for evaluating assessment data, in accordance with an embodiment of the disclosure. FIG. 9 is explained in conjunction with elements from FIG. 1, FIG. 2, FIG. 3, FIG. 4, FIG. 5, FIG. 6, FIG. 7, and FIG. 8. The architecture 900 includes a robust framework designed to validate input data i.e., the assessment data through the interaction of the first AI model and Subject Matter Experts (SMEs). Further, the architecture 900 effectively manages unstructured datasets, transforming them into structured outputs that can be quantitatively assessed. The components of the architecture include a user input 902 received from a user 904 i.e., the first entity. The user input 902 block captures the initial input data i.e., the assessment data provided by users (such as the first entity), typically in the form of unstructured text responses, such as those found in a Security Risk Questionnaire (SRQ). For example, the user 904 may submit a text response detailing their cybersecurity practices, compliance practices, and the like.

Further, the architecture includes an AI model 906 block including the first AI model 208. The first AI model 208 is configured to interpret the user input 902 and apply criteria to evaluate the set of responses in the assessment data. The first AI model 208 processes the unstructured text and generates a structured output in JSON format, which includes key extracted information.

Furthermore, a cybersecurity SME 908 is shown in the architecture. The cybersecurity SME 908 represents human domain experts who perform manual evaluation 910 of the structured outputs generated by the first AI model 208. The cybersecurity SME 908 uses their knowledge and experience to evaluate the same dataset, providing evaluations in a binary format i.e., accepted (1) or rejected (0) based on specific criteria. For example, the cybersecurity SME 908 may reject a submission if it lacks sufficient detail about vulnerability management practices.

Further, data processing 912 operation is performed. In the data processing 912 operation, the user input 902 and the structured JSON output (i.e., a JSON file 914) from the first AI model 208 are processed to ensure consistency and clarity. The transformation from unstructured text to structured JSON allows for easier comparison and evaluation. This process can involve cleaning the data, standardizing formats, and preparing it for analysis. Further, an evaluation 916 operation is performed. In the evaluation 916 operation, the structured outputs of the first AI model 208 are compared with the evaluations provided by cybersecurity SME 908. By aligning the output of the first AI model 208 with the expert assessments, the system 202 measures the performance of the first AI model 208 using quantitative metrics, such as accuracy and F-1 score.

If the output from the first AI model 208 aligns with the cybersecurity SMEs' assessments (e.g., adequate descriptions of security measures), it indicates that the model is functioning accurately. In an embodiment of the disclosure, both the cybersecurity SME 908 and the first AI model 208 generate the binary data 918. The binary data 918 in the evaluation 916 operation serves as a critical metric for assessing the performance of the first AI Model 208 and the quality of user submissions. Represented as either 0 (rejected) or 1 (accepted), this binary evaluation is derived from comparisons between structured JSON output of the first AI Model 208 and the assessments provided by cybersecurity Subject Matter Experts (SMEs). This binary feedback mechanism not only informs users about the adequacy of their submissions but also plays a pivotal role in the continuous training and refinement of the first AI model 208 ensuring that the evaluation process becomes increasingly accurate and efficient over time.

In operation, the system 202 is configured to perform the assessment process for vendors within the supply chain security landscape, addressing the critical need for accurate and timely evaluations before audit assessments. The system 202 begins its operation with the user i.e., the first entity submitting the assessment data through the Supplier Request Questionnaire (SRQ). A significant challenge arises when detailed and accurate information is not readily available, leading to delays and uncertainty regarding a supplier's security practices. The system 202 addresses this issue through an automated pre-processing system that utilizes advanced Large Language Models (LLMs).

When a user inputs their set of responses, the system's LLM analyzes the free-text submissions, transforming the set of responses into a structured JSON format. This structured representation not only standardizes the data but also enhances its clarity and relevance for further evaluation. Since, as the user interacts with the SRQ, the system 202 provides real-time feedback, highlighting specific areas requiring modification or additional information. This immediate feedback mechanism allows vendors to rectify inaccuracies before their submissions are finalized, ensuring that the information is both comprehensive and meets the criteria. Additionally, the system 202 captures anonymized incorrect responses during this process, warehousing them for future reference. This continuous learning capability is used for improving the AI engine's performance over time. By analyzing past mistakes, the system 202 refines its evaluation criteria and adapts to emerging risks in the supply chain landscape. This iterative process not only enhances the accuracy of data submissions but also optimizes the efficiency of the risk assessment workflow, significantly reducing the likelihood of rejections due to poor initial data quality.

As the assessment progresses, the structured output from the LLM is cross-referenced with evaluations performed by cybersecurity Subject Matter Experts (SMEs). This dual-layer validation ensures that the outputs are reliable and aligned with expert standards, facilitating informed decision-making. If discrepancies are identified, the system 202 further engages the feedback generator 704 to provide users with detailed, instruction-specific recommendations, enabling them to correct and improve their submissions effectively.

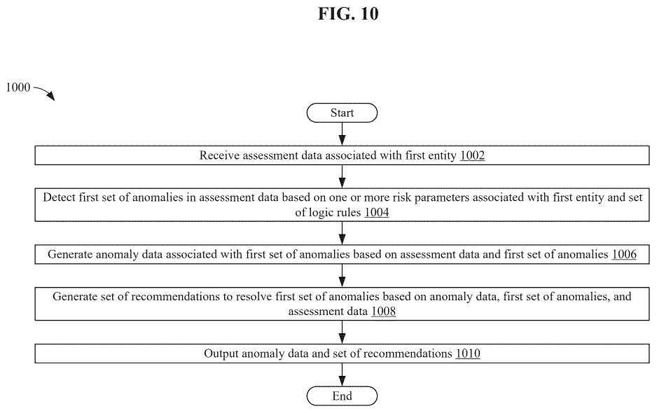

FIG. 10 is a diagram that illustrates a flowchart 1000 of an exemplary computer-implemented method for the detection and management of the anomalies, in accordance with an embodiment of the disclosure. FIG. 10 is explained in conjunction with elements from FIG. 1, FIG. 2, FIG. 3, FIG. 4, FIG. 5, FIG. 6, FIG. 7, FIG. 8, and FIG. 9. The operations of the exemplary computer-implemented method are executed by any computing system, for example, by the computer 102 of FIG. 1 or the system 202 of FIG. 2. The operations of the flowchart 1000 may start at 1002.

At 1002, assessment data associated with a first entity is received. In an embodiment of the disclosure, the assessment data includes at least one of a set of questions or a first set of responses for the set of questions. The set of questions is associated with the evaluation of the first entity conducted by a second entity about an operational activity. In an embodiment of the disclosure, the operational activity is performed by the first entity. Details about the reception of the assessment data are provided, for example, in FIG. 5.

At 1004, a first set of anomalies is detected in the assessment data based on one or more risk parameters associated with the first entity and a set of logic rules. In an embodiment of the disclosure, the set of logic rules is rules associated with the assessment data to evaluate an integrity of the assessment data, an accuracy of the assessment data, and compliance of the assessment data. Details about the detection of the assessment data are provided, for example, in FIG. 3, FIG. 4, FIG. 5, and FIG. 8.

In an embodiment of the disclosure, the first set of anomalies corresponds to a set of issues detected within the assessment data. For example, the set of issues may include incomplete/missing data in the assessment data. For example, if the assessment data requires participants to provide feedback on multiple aspects of a service but some participants skipped this question, the resulting assessment data may be considered as incomplete. The set of issues may also include inconsistent data, which can arise when responses of the participants vary significantly for similar questions or when different participants interpret questions differently. The set of issues may also include incorrect data formatting. The incorrect data formatting occurs when the participants enter data in an unexpected format, such as providing text instead of numerical values or using inconsistent date formats. The incorrect data formatting can complicate data analysis and lead to erroneous conclusions.

In an embodiment of the disclosure, the first set of anomalies may include data integrity anomalies, compliance anomalies, cybersecurity anomalies, operational anomalies, and the like. The data integrity anomalies occur when the assessment data does not meet expected standards of accuracy or completeness. The compliance anomalies arise when the assessment data fails to adhere to regulatory or organizational standards. For example, if a vendor's response times to security incidents are usually within a standard range (e.g., 24-48 hours), but a recent incident took over a week to address, this deviation from the regulatory standard may be flagged as an anomaly. This may suggest issues with the vendor's incident response capabilities or resource allocation. Further, cybersecurity anomalies may include unusual patterns of access to sensitive data or systems. For example, if a vendor reports a low number of phishing attempts (e.g., 1-2 incidents per month), but suddenly reports 15 incidents in a single month, this spike may be considered an anomaly. Such a significant increase may indicate a potential security breach or a failure in the vendor's security protocols, warranting further investigation. Furthermore, operational anomalies refer to unexpected behaviors in operational activities. For example, a manufacturing entity reporting a sudden spike in defect rates. The sudden spike is identified as an anomaly by comparing current performance metrics of the manufacturing entity against historical data of the manufacturing entity.

At 1006, anomaly data associated with the first set of anomalies is generated based on the assessment data and the first set of anomalies. In an embodiment of the disclosure, the anomaly data is indicative of a set of reasons for an occurrence of each anomaly of the first set of anomalies in the assessment data. Details about the determination of the anomaly data are provided, for example, in FIG. 4 and FIG. 5.

At 1008, a set of recommendations is generated based on the anomaly data, the first set of anomalies, and the assessment data. In an embodiment of the disclosure, the set of recommendations is generated to resolve the first set of anomalies. Details about the generation of the set of recommendations are provided, for example, in FIG. 3, FIG. 4, FIG. 5, and FIG. 8.

At 1010, the anomaly data and the set of recommendations are outputted. Details about the outputting of the anomaly data and the set of recommendations are provided, for example, in FIG. 5.

While the above steps shown in FIG. 10 are described in a particular sequence, the steps may occur in variations to the sequence in accordance with various embodiments of the present disclosure. Further, details related to various steps of FIG. 10, which are already covered in the description related to FIG. 1 to FIG. 9 are not discussed again in detail here for the sake of brevity.

The system 202 presents multiple advantages that distinguish it from existing solutions in risk mitigation and information retrieval within the supply chain security context. The system 202 facilitates the implementation of real-time user feedback during the submission process of the assessment data. This proactive engagement allows vendors to correct and enhance their responses immediately, significantly reducing the volume of incorrect or incomplete submissions. By addressing inaccuracies upfront, the system 202 minimizes the need for multiple review cycles, which can otherwise lead to substantial delays in the overall vendor evaluation and approval process, ultimately impacting the timely assessment of third-party risks and the efficiency of supply chain operations. This proactive correction mechanism alleviates the processing load on the system 202 by decreasing the volume of erroneous submissions that require re-evaluation. Further, the proactive correction mechanism also enhances overall efficiency of the system 202 and accelerates data handling, leading to faster decision-making and improved operational responsiveness. The efficiency of the system 202 is improved by providing real-time feedback for immediate corrections, utilizing advanced language processing for accurate evaluations, implementing a continuous learning mechanism to adapt to new challenges, and automating pre-processing tasks, all of which reduce errors in the submission process and accelerate the vendor evaluation process. Furthermore, the system 202 leverages sophisticated language processing capabilities inherent in its embedded AI system. Unlike traditional Natural Language Processing (NLP) processes, the system's use of LLMs ensures a higher accuracy rate in evaluating free-text responses. This advanced analysis allows for a thorough understanding of context, nuances, and intent within the submissions, which lessens the workload on human assessors and increases the likelihood of prompt approvals.

Further, the system 202 performs a continuous learning mechanism. By capturing and anonymizing incorrect responses, the system 202 creates a robust database that informs future model training and tuning. This ongoing refinement ensures that the system 202 can adapt to the evolving risk landscape, maintaining high standards of data accuracy and reliability. As a result, organizations can confidently evaluate and rank their vendors based on accurate risk evaluations. Moreover, the creation of a security-specific database within the system 202 allows for precise model tuning tailored to user inputs. This capability not only enhances the system's evaluation processes but also ensures that the feedback provided is relevant and actionable. The combination of automated pre-processing, real-time feedback, and continuous improvement positions the system 202 as a uniquely capable solution in enhancing third-party risk management security assessments.

Various embodiments of the disclosure may provide a computer program product for the detection and management of anomalies in assessment data. The computer program product includes one or more computer-readable storage media and program instructions stored on the one or more computer-readable storage media to perform operations. The operations include receiving assessment data associated with a first entity. The assessment data includes at least a set of questions and a first set of responses for the set of questions. The set of questions is associated with an evaluation of the first entity conducted by a second entity about an operational activity. The operations further include detecting a first set of anomalies in the assessment data based on one or more risk parameters associated with the first entity and a set of logic rules. The set of logic rules is rules associated with the assessment data to evaluate an integrity of the assessment data, an accuracy of the assessment data, and compliance of the assessment data. Further, the operations include generating anomaly data associated with the first set of anomalies based on the assessment data and the first set of anomalies. The anomaly data is indicative of a set of reasons for an occurrence of each anomaly of the first set of anomalies in the assessment data. The operations further include generating a set of recommendations based on the anomaly data, the first set of anomalies, and the assessment data. The set of recommendations is generated to resolve the first set of anomalies. The operations further include outputting the anomaly data and the set of recommendations.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computer, assessment data associated with a first entity, wherein the assessment data comprises at least a set of questions and a first set of responses for the set of questions, and wherein the set of questions is associated with an evaluation of the first entity conducted by a second entity about an operational activity;
detecting, by the computer, a first set of anomalies in the assessment data based on one or more risk parameters associated with the first entity and a set of logic rules, wherein the set of logic rules is rules associated with the assessment data to evaluate an integrity of the assessment data, an accuracy of the assessment data, and compliance of the assessment data;
generating, by the computer, anomaly data associated with the first set of anomalies based on the assessment data and the first set of anomalies, wherein the anomaly data is indicative of a set of reasons for an occurrence of each anomaly of the first set of anomalies in the assessment data;
generating, by the computer, a set of recommendations based on the anomaly data, the first set of anomalies, and the assessment data, wherein the set of recommendations is generated to resolve the first set of anomalies; and
outputting, by the computer, the anomaly data and the set of recommendations.

2. The computer-implemented method of claim 1, further comprising:
applying, by the computer, a first set of logic rules of the set of logic rules to the assessment data; and
detecting, by the computer, the first set of anomalies in the assessment data based on the one or more risk parameters and the application of the first set of logic rules to the assessment data.

3. The computer-implemented method of claim 2, further comprising:
applying, by the computer, a first Artificial Intelligence (AI) model on the assessment data and the first set of anomalies; and
generating, by the computer, first anomaly data of the anomaly data based on the application of the first AI model on the assessment data and the first set of anomalies, wherein the first anomaly data is indicative of at least a first reason of the set of reasons for the occurrence of each anomaly within the first set of anomalies.

4. The computer-implemented method of claim 3, wherein the first reason is associated with at least one of an absence of at least one response in a first set of responses, an occurrence of incorrect data formatting in the first set of responses, or an occurrence of a set of errors associated with a first set of criteria for the first set of responses.

5. The computer-implemented method of claim 3, further comprising:
applying, by the computer, a second AI model on the first anomaly data, the first set of anomalies, and the assessment data; and
generating, by the computer, a first set of recommendations of the set of recommendations based on the application of the second AI model on the first anomaly data, the first set of anomalies, and the assessment data, wherein the first set of recommendations is generated to resolve the first set of anomalies.

6. The computer-implemented method of claim 5, further comprising:
receiving, by the computer, one or more inputs from a first electronic device associated with the first entity to update the assessment data, wherein the one or more inputs are received based on the outputting of the first set of recommendations on the first electronic device;
updating, by the computer, the assessment data based on the one or more inputs, wherein the updated assessment data comprises at least one updated response associated with the first set of responses;
applying, by the computer, a second set of logic rules of the set of logic rules to the updated assessment data;
detecting, by the computer, a second set of anomalies in the updated assessment data based on the application of the second set of logic rules to the updated assessment data; and
outputting, by the computer, the second set of anomalies.

7. The computer-implemented method of claim 6, further comprising:
applying, by the computer, the first AI model on the updated assessment data and the second set of anomalies;
generating, by the computer, second anomaly data of the anomaly data based on the application of the first AI model on the updated assessment data and the second set of anomalies, wherein the second anomaly data is indicative of at least a second reason of the set of reasons for the occurrence of each anomaly within the second set of anomalies;
applying, by the computer, the second AI model on the second anomaly data, the second set of anomalies, and the updated assessment data;
generating, by the computer, a second set of recommendations of the set of recommendations based on the application of the second AI model on the second anomaly data, the second set of anomalies, and the updated assessment data, wherein the second set of recommendations is generated to resolve the second set of anomalies; and
outputting, by the computer, the second anomaly data, and the second set of recommendations.

8. The computer-implemented method of claim 7, wherein the second reason comprises at least one of an occurrence of one or more logical flaws in the at least one updated response or an absence of at least one section of data in the at least one updated response.

9. The computer-implemented method of claim 7, further comprising:
transmitting, by the computer, the assessment data to a second electronic device associated with the second entity, wherein the second entity is responsible for the evaluation of the first entity about the operational activity;
obtaining, by the computer, response data from the second entity based on the transmission of the assessment data to the second electronic device, wherein the response data is indicative of an occurrence of one or more anomalies in the assessment data;
determining, by the computer, a performance score associated with the first AI model based on the response data and the first set of anomalies, wherein the performance score is associated with a performance of the first AI model for the detection of the first set of anomalies in the assessment data;
validating, by the computer, the performance of the first AI model based on the performance score and a threshold performance score; and
training, by the computer, the first AI model based on the response data and the first set of anomalies upon the validation of the performance of the first AI model.

10. The computer-implemented method of claim 9, further comprising:
obtaining, by the computer, one or more recommendations from the second electronic device to resolve the first set of anomalies upon the transmission of the assessment data to the second electronic device;
validating, by the computer, a performance of the second AI model based on the one or more recommendations and the first set of recommendations; and
training, by the computer, the second AI model based on the one or more recommendations and the first set of recommendations upon the validation of the performance of the second AI model.

11. The computer-implemented method of claim 1, wherein the one or more risk parameters comprise financial stability indicators of the first entity, a regulatory compliance status of the first entity, security posture metrics of the first entity, and an incident history of the first entity.

12. A computer system, comprising:
a processor set;
one or more computer-readable storage media; and
program instructions stored on the one or more computer-readable storage media, the program instructions executable by the processor set to cause the processor set to:
receive assessment data associated with a first entity, wherein the assessment data comprises at least a set of questions and a first set of responses for the set of questions, and wherein the set of questions is associated with an evaluation of the first entity conducted by a second entity about an operational activity;
detect a first set of anomalies in the assessment data based on one or more risk parameters associated with the first entity and a set of logic rules, wherein the set of logic rules is rules associated with the assessment data to evaluate an integrity of the assessment data, accuracy of the assessment data, and compliance of the assessment data;
generate anomaly data associated with the first set of anomalies based on the assessment data and the first set of anomalies, wherein the anomaly data is indicative of a set of reasons for an occurrence of each anomaly of the first set of anomalies in the assessment data; and
generate a set of recommendations based on the anomaly data, the first set of anomalies, and the assessment data, wherein the set of recommendations is generated to resolve the first set of anomalies.

13. The computer system of claim 12, wherein the program instructions further cause the processor set to:
apply a first set of logic rules of the set of logic rules to the assessment data; and
detect the first set of anomalies in the assessment data based on the one or more risk parameters and the application of the first set of logic rules to the assessment data.

14. The computer system of claim 13, wherein the program instructions further cause the processor set to:
apply a first Artificial Intelligence (AI) model on the assessment data and the first set of anomalies; and
generate first anomaly data of the anomaly data based on the application of the first AI model on the assessment data and the first set of anomalies, wherein the first anomaly data is indicative of at least a first reason of the set of reasons for the occurrence of each anomaly within the first set of anomalies.

15. The computer system of claim 14, wherein the first reason is associated with at least one of an absence of at least one response in a first set of responses, an occurrence of incorrect data formatting in the first set of responses, or an occurrence of a set of errors associated with a first set of criteria for the first set of responses.

16. The computer system of claim 14, wherein the program instructions further cause the processor set to:
apply a second AI model on the first anomaly data, the first set of anomalies, and the assessment data; and
generate a first set of recommendations of the set of recommendations based on the application of the second AI model on the first anomaly data, the first set of anomalies, and the assessment data, wherein the first set of recommendations is generated to resolve the first set of anomalies.

17. The computer system of claim 16, wherein the program instructions further cause the processor set to:
receive one or more inputs from a first electronic device associated with the first entity to update the assessment data, wherein the one or more inputs are received based on the output of the first set of recommendations on the first electronic device;
update the assessment data based on the one or more inputs, wherein the updated assessment data comprises at least one updated response associated with the first set of responses;
apply a second set of logic rules of the set of logic rules to the updated assessment data;
detect a second set of anomalies in the updated assessment data based on the application of the second set of logic rules to the updated assessment data; and
output the second set of anomalies.

18. The computer system of claim 17, wherein the program instructions further cause the processor set to:
apply the first AI model to the updated assessment data and the second set of anomalies;
generate second anomaly data of the anomaly data based on the application of the first AI model on the updated assessment data and the second set of anomalies, wherein the second anomaly data is indicative of at least a second reason of the set of reasons for the occurrence of each anomaly within the second set of anomalies;
apply the second AI model on the second anomaly data, the second set of anomalies, and the updated assessment data;
generate a second set of recommendations of the set of recommendations based on the application of the second AI model on the second anomaly data, the second set of anomalies, and the updated assessment data, wherein the second set of recommendations is generated to resolve the second set of anomalies; and
output the second anomaly data and the second set of recommendations.

19. The computer system of claim 12, wherein the one or more risk parameters comprise financial stability indicators of the first entity, a regulatory compliance status of the first entity, security posture metrics of the first entity, and an incident history of the first entity.

20. A computer program product for a determination and a resolution of a first set of anomalies in assessment data associated with a first entity, the computer program product comprising:
one or more computer-readable storage media; and
program instructions stored on the one or more computer-readable storage media to perform operations comprising:
receiving assessment data associated with a first entity, wherein the assessment data comprises at least a set of questions and a first set of responses for the set of questions, and wherein the set of questions is associated with an evaluation of the first entity conducted by a second entity about an operational activity;
detecting the first set of anomalies in the assessment data based on one or more risk parameters associated with the first entity and a set of logic rules, wherein the set of logic rules is rules associated with the assessment data to evaluate an integrity of the assessment data, accuracy of the assessment data, and compliance of the assessment data;
generating anomaly data associated with the first set of anomalies based on the assessment data and the first set of anomalies, wherein the anomaly data is indicative of a set of reasons for an occurrence of each anomaly of the first set of anomalies in the assessment data;
generating a set of recommendations based on the anomaly data, the first set of anomalies, and the assessment data, wherein the set of recommendations is generated to resolve the first set of anomalies; and
outputting the anomaly data and the set of recommendations.
